(19) United States
(12) Patent Application Publication
(10) Pub. No.: US 2026/0276140 A1
(43) Pub. Date: Sep. 17, 2026

(54) MAINTENANCE SUPPORT AND MAINTENANCE SUPPORT ASSEMBLY

(71) Applicant: RONGRONG LI, XIAMEN (CN)

(72) Inventor: RONGRONG LI, XIAMEN (CN)

(21) Appl. No.: 19/087,364

(22) Filed: Mar. 21, 2025

(30) Foreign Application Priority Data
Mar. 12, 2025 (CN) 202520428428.X

(51) Int. Cl. F16M 13/02; F16B 47/00

(52) U.S. Cl. CPC F16M 13/022; F16B 47/006

(57) ABSTRACT

A maintenance support and a maintenance support asse3mbly are provided. The maintenance support includes a support body, suction cups, and mounting assemblies. The support body includes first sliding grooves. The first sliding grooves extend in a first direction. Each of the mounting assemblies is movably mounted in a corresponding one of the first sliding grooves and is movable in the corresponding one of the first sliding grooves along the first direction. Each of the suction cups is mounted on a corresponding one of the mounting assemblies. The suction cups are close to or away from each other through the mounting assemblies

### TECHNICAL FIELD

The present disclosure relates to a technical field of assistive tools, and in particular to a maintenance support and a maintenance support assembly.

### BACKGROUND

With popularity of skiing, maintenance of ski boards is particularly important. Good maintenance not only extends service life of the ski boards, but also improve a skiing experience. In order to facilitate the maintenance of the ski boards, ski maintenance supports become an indispensable tool. However, conventional ski maintenance supports have poor adaptability when matching with the ski boards of different sizes.

### SUMMARY

Embodiments of the present disclosure provide a maintenance support and a maintenance support assembly, which improve adaptability of the maintenance support.

In a first aspect, the present disclosure provides a maintenance support. The maintenance support comprises a support body, suction cups, and mounting assemblies. The support body comprises first sliding grooves. The first sliding grooves extend in a first direction. Each of the mounting assemblies is movably mounted in a corresponding one of the first sliding grooves and is movable in the corresponding one of the first sliding grooves along the first direction. Each of the suction cups is mounted on a corresponding one of the mounting assemblies. The suction cups are close to or away from each other through the mounting assemblies.

Optionally, the first sliding grooves are disposed at intervals in the first direction. The mounting assemblies are one-to-one mounted in the first sliding grooves, and the suction cups are one-to-one corresponding to the first sliding grooves.

Optionally, each of the mounting assemblies comprises a connecting piece and a locking piece. A first end of each connecting piece is connected to a corresponding one of the suction cups. Each connecting piece passes through a corresponding one of the first sliding grooves in a second direction. A second end of each connecting piece is connected to a corresponding locking piece. Each locking piece cooperates with the second end of a corresponding connecting piece to lock or unlock a corresponding one of the suction cups relative to the support body. The second direction intersects with the first direction.

Optionally, each connecting piece comprises a locking screw. Each locking screw is screwed with a corresponding one of the suction cups. Each locking screw passes through a corresponding one of the first sliding grooves. Each locking piece comprises a nut, and each nut is screwed with a corresponding locking screw.

Optionally, the support body comprises first plates and second plates disposed opposite to first plates. The first sliding grooves are respectively defined on the first plates. Second sliding grooves corresponding to the first sliding grooves are respectively defined on the second plates. The first plates and the second plates are disposed at intervals. A spacing groove is defined between each of the first plates and a corresponding one of the second plates. Each connecting piece further passes through a corresponding spacing groove and a corresponding one of the second sliding grooves. Each locking piece is disposed in a corresponding spacing groove.

Optionally, each of the suction cups abuts against a corresponding one of the first plates. Each of the suction cups comprises a cup body and a cup seat. Each cup body is disposed around a corresponding cup seat. Each cup seat is screwed with a corresponding connecting piece.

The maintenance support further comprises first sealing rings. Each of the first sealing rings is disposed between a corresponding cup seat and a corresponding connecting piece.

Optionally, each connecting piece comprises an axial through hole. Each cup seat comprises an opening communicated with an interior of a corresponding one of the suction cups. Each opening is further communicated with a corresponding axial through hole.

Each of the mounting assemblies further comprises a pressure relief rod, a sealing piece, and a driving portion. Each pressure relief rod is disposed in a corresponding axial through hole. Each sealing piece is disposed between a first end of a corresponding pressure relief rod and a corresponding cup seat. A second end of each pressure relief rod is connected to a corresponding driving portion. Each driving portion is configured to drive a corresponding pressure relief rod to move toward or away from a corresponding cup seat to seal or expose the opening of a corresponding cup seat.

Optionally, each of the mounting assemblies further comprises an elastic piece. Each elastic piece is elastically connected to a corresponding pressure relief rod. Each elastic piece is configured to provide elastic force to force a corresponding pressure relief rod and a corresponding sealing piece to seal the opening of a corresponding cup seat.

Optionally, each pressure relief rod has a first section and a second section connected to the first section. A first end of the first section of each pressure relief rod away from a corresponding second section is connected to a corresponding sealing piece. A diameter of each second section is less than a diameter of each first section. Each elastic piece is sleeved on a corresponding second section.

Each of the mounting assemblies further comprises a limiting portion. Each limiting portion is mounted on a corresponding second section and located on one side of a corresponding elastic piece away from a corresponding first section. Each elastic piece is elastically mounted between a corresponding second section and a corresponding limiting portion.

Optionally, each limiting portion comprises a gasket and a stop ring. Each gasket and each stop ring are sleeved on a corresponding second section. Each gasket is disposed between a corresponding elastic piece and a corresponding stop ring. Each stop ring is mounted in a corresponding second section.

Optionally, one end of a side wall of each axial through hole close to a corresponding cup seat defines an inclined surface. A protrusion protruding toward a corresponding cup seat is disposed on each first section. Each sealing piece comprises a second sealing ring. Each second sealing ring is sleeved on a corresponding protrusion.

Each elastic piece enables each second sealing ring to abut between the corresponding protrusion and the inclined surface of a corresponding axial through hole to seal a corresponding opening. Each driving portion is configured to drive the corresponding pressure relief rod to drive a corresponding second sealing ring to move, so that each second sealing ring separates from the inclined surface of the corresponding protrusion and exposes the corresponding opening.

Optionally, each driving portion is rotatably connected to the corresponding pressure relief rod, and each driving portion is rotatable between a first position and a second position.

When each driving portion is in the first position, each driving portion and a corresponding one of the second plates are spaced apart from each other, and each elastic piece enables the corresponding second sealing ring to abut between the corresponding protrusion and the inclined surface of the corresponding axial through hole to seal the corresponding opening.

When each driving portion is in the second position, each driving portion drives the corresponding pressure relief rod to drive the corresponding second sealing ring to move, so that each second sealing ring separates from the inclined surface of the corresponding axial through hole and exposes the corresponding opening.

Optionally, each driving portion comprises a pressure relief lever and a lever pin. A first mounting hole is defined on a second end of each pressure relief rod. A second mounting hole is defined on each pressure relief lever. Each lever pin is disposed in a corresponding first mounting hole and a corresponding second mounting hole, so that each pressure relief lever is rotatably connected to a corresponding pressure relief rod.

Each pressure relief lever is rotatable relative to the corresponding pressure relief rod between the first position and the second position, so that each second sealing ring seals or exposes the corresponding opening.

Optionally, each pressure relief lever comprises a first surface and a second surface adjacent to the first surface. A minimum distance between the first surface of each pressure relief lever and a corresponding second mounting hole is less than a minimum distance between the second surface of each pressure relief lever and a corresponding second mounting hole.

When each pressure relief lever is in the first position, the first surface of each pressure relief lever is opposite to and spaced from a corresponding one of the second plates. When each pressure relief lever is in the second position, the second surface of each pressure relief lever abuts against a corresponding one of the second plates and drives a corresponding pressure relief rod, and each pressure relief rod drives the corresponding second seal ring to move.

Optionally, the maintenance support further comprises a mounting piece, and the mounting piece is detachably mounted on a bearing portion.

Optionally, the support body comprises a first mounting plate and a second mounting plate disposed opposite to the first mounting plate.

The mounting piece comprises a mounting seat and a mounting screw. The mounting seat is disposed between the first mounting plate and the second mounting plate. The mounting screw passes through the second mounting plate and is screwed with the second mounting plate. The mounting seat is fixedly connected to the mounting screw.

Optionally, an axial direction of the mounting screw intersects with the first direction. The second mounting plate is adjacent to one side of the first mounting plate away from the suction cups.

Optionally, the support body is made of metal.

Optionally, a diameter of each of the suction cups is less than 80 mm.

In a second aspect, the present disclosure provides a maintenance support assembly. The maintenance support assembly comprises at least one ski board and the maintenance support mentioned above. The suction cups are attached to the at least one ski board.

In the embodiments of the present disclosure the support body of the maintenance support comprises the first sliding grooves which provide moving tracks of the mounting assemblies, so that each of the mounting assemblies is movable freely in the corresponding one of the first sliding grooves along the first direction. The suction cups are respectively mounted on the mounting assemblies and change their positions along with movement of the mounting assemblies. The suction cups are configured to suck and fix the at least one ski board, so positions of the suction cups are flexibly adjusted according to a size of the at least one ski board. Therefore, the suction cups are close to or far away from each other, thereby adapting to ski boards of different sizes. For example, for a narrow snowboard, a user may move the suction cups close to each other to concentrate suction forces and ensure that the narrow snowboard is firmly fixed. For a wide snowboard, the user may move the suction cups away from each other to cover a larger area and provide a more balanced suction force, thereby improving the versatility and adaptability of the maintenance support. Moreover, in actual use, the user only needs to adjust a position of each of the mounting assemblies in the corresponding one of the first sliding grooves to quickly adjust a position of each of the suction cups without complicated operations, thereby improving the convenience of use of the maintenance support.

In addition, the maintenance support comprises the suction cups, which provide suction points for at least one ski board, ensuring that the at least one ski board is firmly fixed during a maintenance process, preventing the at least ski board from sliding or shifting during the maintenance process, thereby improving the stability and safety of maintenance operations. Moreover, a design of the maintenance support provided with the suction cups enables the maintenance support to adapt to a variety of ski board types. For example, when the at least one ski board is a wide snowboard, the suction cups evenly distribute the suction force, which effectively prevents the snowboard from being unevenly stressed due to its wide width, and avoids warping or shaking during the maintenance process. When the at least one ski board is a pair of ski blades, the suction cups are simultaneously attached to the pair of ski blades, so that each of the ski blades is fixed independently. Furthermore, by adjusting the positions of the suction cups, mutual interference between the pair of ski blades is avoided. Therefore, by providing the suction cups that are capable of being flexibly adjusted, the maintenance support of the embodiments of the present disclosure is adapted to not only ski boards of different sizes but also ski boards of different types, which significantly improves practicality and adaptability of the maintenance support.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

For a complete understanding of the present disclosure and its characteristics, the following description will be made in conjunction with the accompanying drawings, where same reference numbers in the following description indicate same structures.

FIG. 1 is a schematic diagram of a maintenance support according to one embodiment of the present disclosure.

FIG. 2 is an exploded schematic diagram of the maintenance support shown in FIG. 1.

FIG. 3 is another schematic diagram of the maintenance support shown in FIG. 1.

FIG. 4 is another schematic diagram of the maintenance support shown in FIG. 1.

FIG. 5 is a cross-sectional schematic diagram of the maintenance support taken along the line A-A shown in FIG. 4.

FIG. 6 is a cross-sectional schematic diagram of the maintenance support shown in FIG. 1 where the maintenance support is connected to a snowboard.

FIG. 7 is a cross-sectional schematic diagram of the maintenance support shown in FIG. 6 where suction cups connected to the snowboard are in positions closest to each other.

FIG. 8 is a cross-sectional schematic diagram of the maintenance support shown in FIG. 6 where the suction cups connected to the snowboard are in positions farthest to each other.

FIG. 9 is a cross-sectional schematic diagram of the maintenance support shown in FIG. 1 where the maintenance support is connected to a pair of ski blades.

FIG. 10 is a cross-sectional schematic diagram of the maintenance support shown in FIG. 9 where the suction cups are pressed downward.

FIG. 11 is a cross-sectional schematic diagram of the maintenance support shown in FIG. 10 where each driving portion is in a second position.

FIG. 12 is a cross-sectional schematic diagram of the maintenance support shown in FIG. 6 where the suction cups are pressed downward.

FIG. 13 is a cross-sectional schematic diagram of the maintenance support shown in FIG. 12 where each driving portion is in the second position.

FIG. 14 is a schematic diagram of a pressure relief lever of the maintenance support shown in FIG. 1.

Reference Numerals in the Drawings:

1—maintenance support; 10—support body; 12—first plate; 121—first sliding groove; 13—spacing groove; 14—second plate; 141—second sliding groove; 16—first mounting plate; 18—second mounting plate; 20—mounting assembly; 21—connecting piece; 212—locking screw; 22—locking piece; 222—nut; 23—pressure relief rod; 232—first section; 233—protrusion; 234—second section; 24—sealing piece; 25—driving portion; 252—pressure relief lever; 253—first surface; 255—second surface; 256—leverpin; 26—elastic piece; 27—limiting portion; 272—gasket; 274—stop ring; 30—suction cup; 32—cup body; 34—cup seat; 341—opening; 40—first sealing ring; 50—mounting piece; 52—mounting seat; 54—mounting screw; 6—ski board.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. The following description of at least one exemplary embodiment is merely illustrative and is in no way intended as any limitation on the present disclosure, applications thereof, and use thereof. Based on the embodiments of the present disclosure, all other embodiments obtained by those of ordinary skill in the art without creative work shall fall within the protection scope of the present disclosure.

Reference herein to “embodiment” or “implement” means that a particular feature, structure, or characteristic described in connection with one embodiment or one implement may be included in at least one embodiment of the present disclosure. The appearances of the “embodiment” in various positions in the specification are not necessarily referring to the same embodiment, and are not independent or alternative embodiments mutually exclusive of other embodiments. Those skilled in the art explicitly and implicitly understand that the embodiments described herein may be combined with other embodiments.

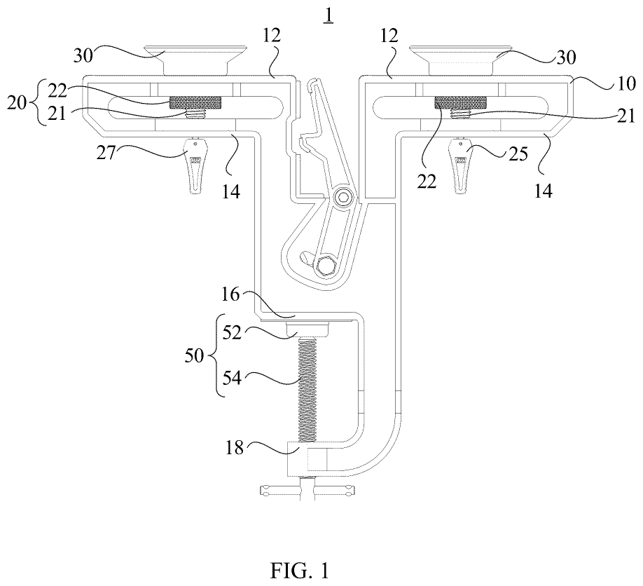

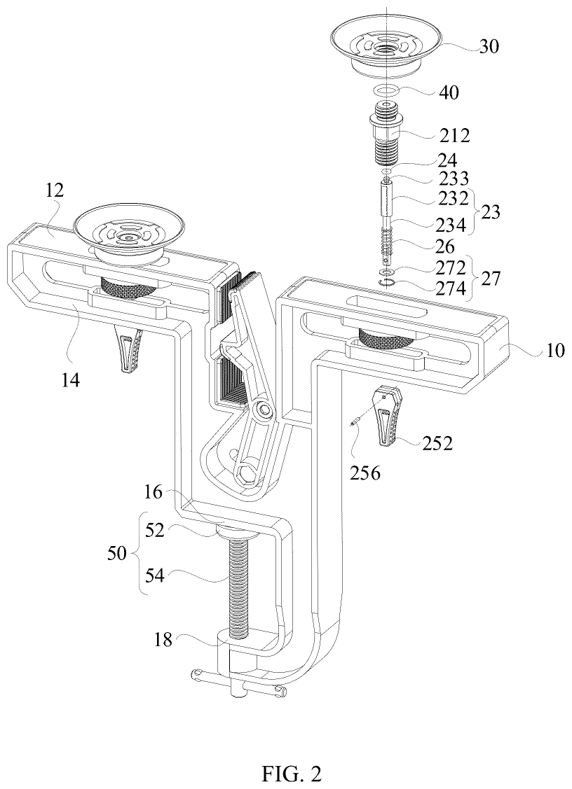

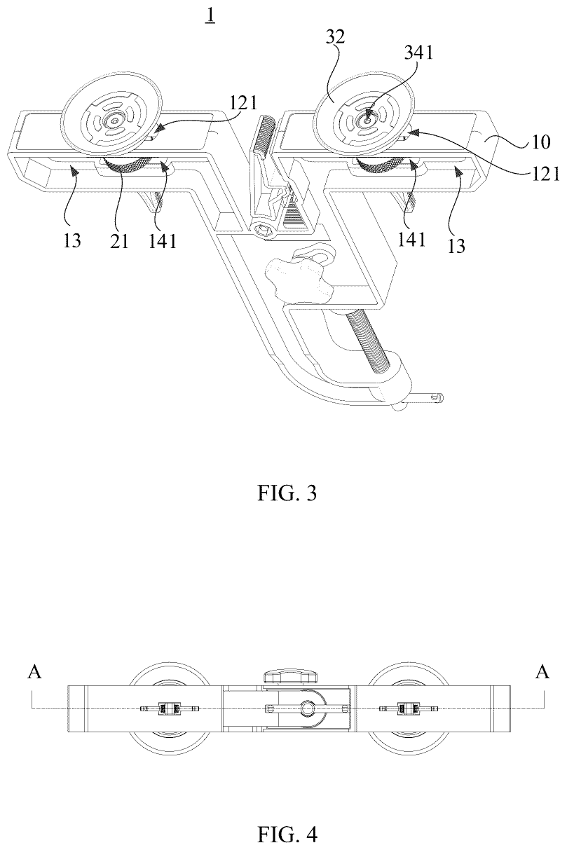

As shown in FIGS. 1-3, FIG. 1 is a schematic diagram of a maintenance support according to one embodiment of the present disclosure, FIG. 2 is an exploded schematic diagram of the maintenance support shown in FIG. 1, and FIG. 3 is another schematic diagram of the maintenance support shown in FIG. 1. The present disclosure provides a maintenance support 1. The maintenance support 1 comprises a support body 10, suction cups 30, and mounting assemblies 20. The support body 10 comprises first sliding grooves 121. The first sliding grooves 121 extend in a first direction. Each of the mounting assemblies 20 is movably mounted in a corresponding one of the first sliding grooves 121 and is movable in the corresponding one of the first sliding grooves 121 along the first direction. Each of the suction cups 30 is mounted on a corresponding one of the mounting assemblies 20. The suction cups 30 are close to or away from each other through the mounting assemblies 20.

The maintenance support 1 comprises the first sliding grooves 121, which provide moving tracks of the mounting assemblies 20, so that each of the mounting assemblies 20 is movable freely in the corresponding one of the first sliding grooves 121 along the first direction. The suction cups 30 are respectively mounted on the mounting assemblies 20 and change their positions along with movement of the mounting assemblies 20. The suction cups 30 are configured to suck and fix at least one ski board 6, so positions of the suction cups 30 are flexibly adjusted according to a size of the at least one ski board 6. Therefore, the suction cups 30 are close to or far away from each other, thereby adapting to ski boards of different sizes. For example, for a narrow snowboard, a user may move the suction cups 30 close to each other to concentrate suction forces and ensure that the narrow snowboard is firmly fixed. For a wide snowboard, the user may move the suction cups 30 away from each other to cover a larger area and provide a more balanced suction force, thereby improving the versatility and adaptability of the maintenance support 1. Moreover, in actual use, the user only needs to adjust a position of each of the mounting assemblies 20 in the corresponding one of the first sliding grooves 121 to quickly adjust a position of each of the suction cups 30 without complicated operations, thereby improving the convenience of use of the maintenance support 1.

In addition, the maintenance support 1 comprises the suction cups 30, which provide suction points for the at least one ski board 6, ensuring that the at least one ski board 6 is firmly fixed during a maintenance process, preventing the at least ski board 6 from sliding or shifting during the maintenance process, thereby improving the stability and safety of maintenance operations. Moreover, a design of the maintenance support 1 provided with the suction cups 30 enables the maintenance support 1 to adapt to a variety of ski board types. For example, when the at least one ski board 6 is a wide snowboard 6, the suction cups 30 evenly distribute the suction force, which effectively prevents the snowboard 6 from being unevenly stressed due to its wide width, and avoids warping or shaking during the maintenance process. When the at least one ski board 6 is a pair of ski blades 6, the suction cups 30 are simultaneously attached to the pair of ski blades 6, so that each of the ski blades 6 is fixed independently. Furthermore, by adjusting the positions of the suction cups 30, mutual interference between the pair of ski blades 6 is avoided. Therefore, by providing the suction cups 30 that are capable of being flexibly adjusted, the maintenance support 1 of the embodiment of the present disclosure is adapted to not only ski boards of different sizes but also ski boards of different types, which significantly improves practicality and adaptability of the maintenance support.

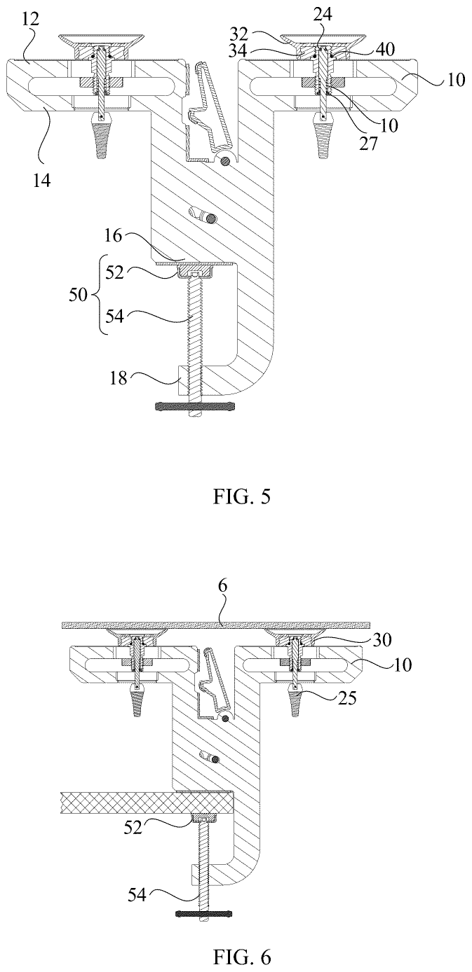

As shown in FIGS. 4-5, FIG. 4 is another schematic diagram of the maintenance support shown in FIG. 1, and FIG. 5 is a cross-sectional schematic diagram of the maintenance support shown in FIG. 4. In some embodiments, the first sliding grooves 121 are disposed at intervals in the first direction. The mounting assemblies 20 are one-to-one mounted in the first sliding grooves 121. The suction cups 30 are one-to-one mounted in the first sliding grooves 121.

In the embodiments, the first sliding grooves 121 are defined on the support body 10, the mounting assemblies 20 are one-to-one movably mounted in the first sliding grooves 121, and the suction cups 30 are one-to-one fixed on the mounting assemblies 20. Therefore, a one-to-one correspondence is formed between the first sliding grooves 121, the mounting assemblies 20, and the suction cups 30, and each of the mounting assemblies 20 is movable independently in the corresponding one of the first sliding grooves 121, thereby independently driving the corresponding one of the suction cups 30 to flexibly adjust a position thereof along the first direction. Therefore, the maintenance support 1 of the embodiment is not only provided with the suction cups 30, but also each of the suction cups 30 is allowed to independently adjust the position thereof without interfering other suction cup. The user is able to flexibly and independently adjust the position of each of the suction cups 30 according to a specific shape, a width and a type of the at least one ski board 6, so that the suction force act evenly on a surface of the at least one ski board 6 and evenly support the at least one ski board 6, thereby effectively preventing the at least one ski board 6 from shifting or tilting during the maintenance process. The maintenance support 1 is particularly suitable for maintenance scenarios that require delicate operations, such as maintaining blades thereof or waxing. The maintenance support 1 ensures that the at least one ski board 6 remains stable during the maintenance process, thereby improving the stability and safety of the maintenance support 1.

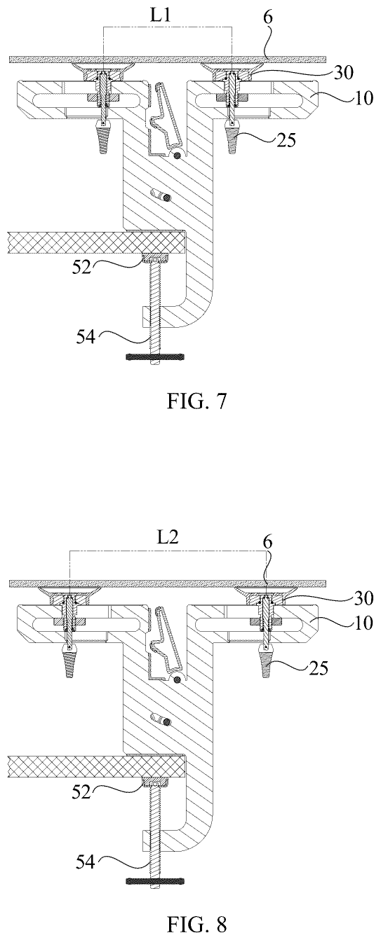

As shown in FIGS. 6-8, FIG. 6 is a schematic diagram of the maintenance support shown in FIG. 1 where the maintenance support is connected to the snowboard, FIG. 7 is a schematic diagram of the maintenance support shown in FIG. 6 where the suction cups connected to the snowboard are in positions closest to each other, and FIG. 8 is a schematic diagram of the maintenance support shown in FIG. 6 where the suction cups connected to the snowboard are in positions farthest to each other.

For instance, in a length direction of the maintenance support 1, two first sliding grooves 121 are respectively defined on two ends of the support body 10, and each of the suction cups 30 is mounted on the corresponding one of the first sliding grooves 121 through the corresponding one of the mounting assemblies 20. The user is allowed to independently adjust the position of each of the suction cups 30 as needed. As shown in the figures, a distance between the two suction cups 30 is adjusted between L1 and L2. When the maintenance support 1 is configured to support the snowboard 6 that is wide, positions of the two suction cups 30 are adjusted independently. For example, the two suction cups 30 are moved away from each other, so that the two suction cups 30 are attached to two sides of the snowboard 6 to form a symmetrical support structure, so as to avoid the snowboard 6 from tilting or shaking due to uneven force during the maintenance process, and ensure that the snowboard 6 remains stable during operation. When the maintenance support 1 is configured to support the snowboard 6 that is narrow, the user is also able to move the two suction cups 30 closer to each other to concentrate the suction force, thereby ensuring that the snowboard 6 that is narrow is firmly fixed, and avoiding the poor support effect caused by the excessive spacing between the two suction cups 30.

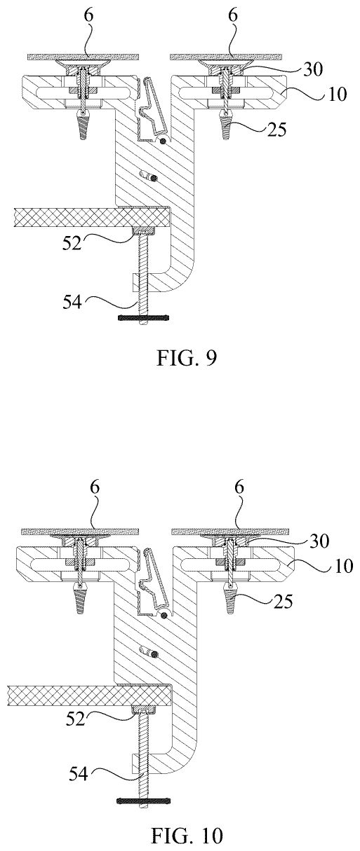

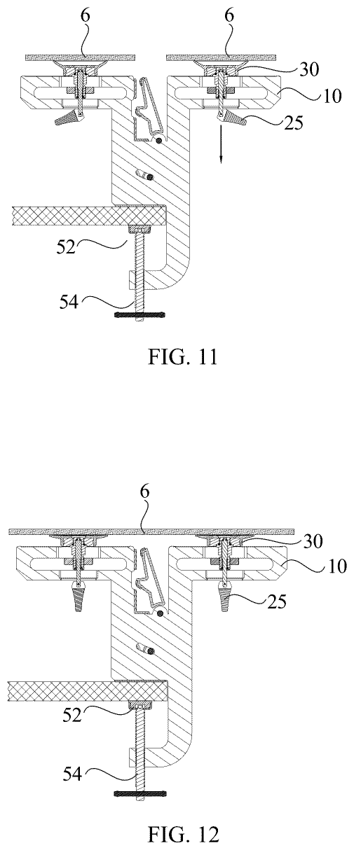

As shown in FIGS. 9-11, FIG. 9 is a schematic diagram of the maintenance support shown in FIG. 1 where the maintenance support is connected to the pair of ski blades, FIG. 10 is a schematic diagram of the maintenance support shown in FIG. 9 where the suction cups are pressed downward, and FIG. 11 is a schematic diagram of the maintenance support shown in FIG. 10 where each driving portion is in a second position. The maintenance support 1 of the embodiment is able to be adapted to both the pair of ski blades 6 and the snowboard 6. When the maintenance support 1 is configured to support the pair of ski blades 6 that is narrow, the two suction cups 30 suck two ski blades 6 at the same time, so that each of the ski blades 6 is independently fixed. By adjusting the position of each of the suction cups 30, mutual interference between the two ski blades 6 is avoided. As shown in the figures, during use, when the two ski blades 6 are not pressed down, each of the suction cups 30 defines a cavity therein, and the suction cups 30 do not form a negative pressure environment at this time. After the two ski blades 6 are pressed down, each of the suction cups 30 is in close contact with a surface of a corresponding one of the ski blades 6, and the air inside each of the suction cups 30 is extruded out to form a negative pressure environment, so that each of the suction cups 30 firmly sucks the corresponding one of the ski blades 6. When the ski blades 6 need to be removed, the user is able to turn a pressure relief lever 252 of each driving portion 25 to drive a corresponding pressure relief rod 23 to pull down, so that each of the suction cups 30 is communicated with an outside. At this time, air enters the suction cups 30, the negative pressure environment is destroyed, and the suction cups 30 no longer suck the ski blades 6, thereby achieving rapid detachment of the ski blades 6. The embodiment not only realizes the independent fixation of the two ski blades 6, but also realizes rapid suction and release of the suction cups 30 through simple operation, thereby improving the practicality and operational convenience of the maintenance support 1.

It should be noted that two first sliding grooves 121 are defined on the support body 10 for illustrative purpose only, and two suction cups 30 are provided accordingly. However, more sliding grooves and suction cups 30 may be added according to actual needs, which are not limited in the embodiment. For example, a third sliding groove and a third one of the suction cup 30 are added in a middle portion of the support body 10 to form a three-point support structure, which further enhances the uniformity of the distribution of the suction force, and is particularly suitable for the snowboard 6 that is long and heavy, thereby providing a more stable fixing effect.

In some embodiments, each of the mounting assemblies 20 comprises a connecting piece 21 and a locking piece 22. A first end of each connecting piece 21 is connected to a corresponding one of the suction cups 30. Each connecting piece 21 passes through a corresponding one of the first sliding grooves 121 in a second direction. A second end of each connecting piece 21 is connected to a corresponding locking piece 22. Each locking piece 22 cooperates with the second end of a corresponding connecting piece 21 to lock or unlock a corresponding one of the suction cups 30 relative to the support body 10. The second direction intersects with the first direction.

In the embodiment, each locking piece 22 and the corresponding one of the suction cups 30 are disposed on two opposite sides of a corresponding one of the first sliding grooves 121, each connecting piece 21 is inserted into the corresponding one of the first sliding grooves 121, and the two ends of each connecting piece are respectively connected to the corresponding locking piece 22 and the corresponding one of the suction cups 30. The first end of each connecting piece 21 is connected to the corresponding one of the suction cups 30, such as by a thread, a snap or other fixing method, to ensure that each of the suction cups 30 is movable with a corresponding connecting piece 21. Each connecting piece 21 is inserted into the corresponding one of the first sliding grooves 121 in the second direction, so that each connecting piece 21 is movable in the corresponding one of the first sliding grooves 121 in the first direction. The second end of each connecting piece 21 is connected to the corresponding locking piece 22, such as by a thread, a slot or other connection method to cooperate with the corresponding locking piece 22, so as to achieve locking or unlocking the position of each of the suction cups 30. For instance, through cooperation between each connecting piece 21 and the corresponding one of the first sliding grooves 121, each of the suction cups 30 is movable freely in the first direction, and the user is able to flexibly adjust the position of each of the suction cups 30. After each of the suction cups 30 is adjusted to a suitable position, each locking piece 22 is operated to effectively fix the position of the corresponding connecting piece 21, thereby ensuring that each of the suction cups 30 does not move during the maintenance process and ensuring the stability of the maintenance support 1.

When the position of any one of the suction cups 30 needs to be adjusted again, a fixing relationship of the corresponding locking piece 22 to the corresponding connecting piece 21 is released, and the corresponding connecting piece 21 is restored to a free state. The user is able to move the one of the suction cups 30 to a desired position. After the one of the suction cups 30 moves to the desired position, the user is sable to operate the corresponding locking piece 22 again to fix the one of the suction cups 30 in the desired position. Therefore, the maintenance support 1 of the embodiment of the present disclosure not only realizes flexible adjustment of the position of each of the suction cups 30, but also ensures the stability of each of the suction cups 30 during the maintenance process through the corresponding locking piece 22.

Exemplarily, the first direction is perpendicular to the second direction, the first direction is the length direction of the maintenance support 1, and the second direction is a height direction of the maintenance support 1.

In some embodiments, each connecting piece 21 comprises a locking screw 212. Each locking screw 212 is screwed with a corresponding one of the suction cups 30. Each locking screw 212 passes through a corresponding one of the first sliding grooves 121. Each locking piece 22 comprises a nut 222, and each nut 222 is screwed with a corresponding locking screw 212.

In the embodiment, a first end of each locking screw 212 is screwed with the corresponding one of the suction cups 30 to ensure that the corresponding one of the suction cups 30 is able to move with each locking screw 212. Each locking screw 212 is inserted into the corresponding one of the first sliding grooves 121 in the second direction. A thread is disposed on a second end of each locking screw 212, and the thread of each locking screw is configured to cooperate with the corresponding nut 222. After the user moves each of the suction cups 30 to the desired positions, the user rotates the corresponding nut 222 in the direction (such as clockwise) of locking the corresponding locking screw 212 to lock the corresponding locking screw 212, so as to limit the movement of each locking screw 212 and each of the suction cups 30. Thus, each of the suction cups 30 is firmly locked in the desired position to prevent each of the suction cups 30 from moving during the maintenance process. When the user rotates each nut 222 in a unlocking direction (such as counterclockwise), each nut 222 moves away from the corresponding one of the first sliding grooves 121 along the thread of the corresponding locking screw 212, and each locking screw 212 and each of the suction cups 30 return to the free state. At this time, the user may move each locking screw 212 and each of the suction cups 30 to the desired position as needed. In the embodiment, each nut 222 is screwed with the corresponding locking screw 212, a structure thereof is simple and reliable, ensuring the long-term stability of a locking function. The user only needs to rotate each nut 222 to complete the locking or unlocking operation of the corresponding one of the suction cups 30 without additional tools, and the operation method is convenient.

In some embodiments, the support body 10 comprises first plates 12 and second plates 14 disposed opposite to first plates 12. The first sliding grooves 121 are respectively defined on the first plates 12. Second sliding grooves 141 corresponding to the first sliding grooves 121 are respectively defined on the second plates 14. The first plates 12 and the second plates 14 are disposed at intervals. A spacing groove 13 is defined between each of the first plates 12 and a corresponding one of the second plates 14. Each connecting piece 21 further passes through a corresponding spacing groove 13 and a corresponding one of the second sliding grooves 141. Each locking piece 22 is disposed in a corresponding spacing groove 13.

In the embodiment, the support body 10 comprises the first plates 12 and the second plates 14 disposed opposite to the first plates 12, which increases an overall structural strength of the support body 10. Each of the first plates 12 and the corresponding one of the second plates 14 are spaced a certain distance apart to form the corresponding spacing groove 13. The first plates 12 respectively defines the first sliding grooves 121, and the second plates 14 respectively defines the second sliding grooves 141 corresponding to the first sliding grooves 121. Each connecting pieces 21 passes through the corresponding one of the first sliding grooves 121, the corresponding spacing groove 13, and the corresponding one of the second sliding grooves 141 to ensure that each connecting piece 21 maintains a straight line motion during the movement to avoid shaking or deviation.

The first end of each connecting piece 21 is connected to the corresponding one of the suction cups 30. The second end of each connecting piece 21 extends into the corresponding spacing groove 13 and cooperates with the corresponding locking piece 22. Each spacing groove 13 provides mounting space for the corresponding locking piece 22 and avoids interference between the corresponding locking piece 22 and other components. The user is also allowed to operate the corresponding locking piece 22 through each spacing groove 13.

Exemplarily, each connecting piece 21 is the locking screw 212, and each locking piece 22 is the nut 222. By rotating each nut 222, each nut 222 moves along the thread of the corresponding locking screw 212 toward the corresponding first one of the sliding grooves 121, and cooperates with the corresponding one of the suction cups 30 to press the corresponding one of the first plates 12 from two sides of the corresponding one of the first plates 12, thereby realizing the locking of the position of each of the suction cups 30. By rotating each nut 222 in the opposite direction, the pressing force is released to restore each of the suction cups 30 to the free state. Therefore, the support body 10 of the embodiment is a double-layer plate structure, which enhances the stability of the support body 10, optimizes a movement trajectory of each connecting piece 21, and facilitates the mounting and operation of each locking piece 22.

In some embodiments, a radial direction of each nut 222 is understood as a thickness direction of the maintenance support 1. Each nut 222 may exceed the corresponding spacing groove 13, so that it is convenient for the user to rotate each nut 222. In some other embodiments, each nut 222 may not exceed the corresponding spacing groove 13, so as to reduce a thickness of the maintenance support 1.

In some embodiments, in the first direction, a ratio of a length of each of the first sliding grooves 121 to a length of each spacing groove 13 is 0.3-0.7.

In the embodiment, by reasonably setting the ratio of the length of each of the first sliding grooves 121 and the length of each spacing groove 13, a space of the support body 10 is efficiently utilized, which not only allows the suction cups 30 to move within a sufficient range to adapt to ski boards of different sizes, but also enables the first sliding grooves 121 to be defined on the support body 10 and the suction cups 30 to be mounted accordingly, thereby providing more suction points. In addition, the reasonable ratio of the length of each of the first sliding grooves 121 and the length of each spacing groove 13 further ensures the structural strength of the support body 10, so the support body 10 is not easy to deform or damage when subjected to external force.

In some embodiments, each of the suction cups 30 abuts against a corresponding one of the first plates 12. Each of the suction cups 30 comprises a cup body 32 and a cup seat 34. Each cup body 32 is disposed around a corresponding cup seat 34. Each cup seat 34 is screwed with a corresponding connecting piece 21. The maintenance support 1 further comprises first sealing rings 40. Each of the first sealing rings 40 is disposed between a corresponding cup seat 34 and a corresponding connecting piece 21.

In the embodiment, each cup seat 34 is screwed with the corresponding connecting piece 21 (such as the corresponding locking screw 212), ensuring that each of the suction cups 30 moves with the corresponding connecting piece 21 (such as the corresponding locking screw 212). Each cup seat 34 abuts against the corresponding one of the first plates 12. Each of the first sealing rings 40 is disposed between the corresponding cup seat 34 and the corresponding connecting piece 21 (such as the corresponding locking screw 212), and is configured to seal a connection area between the two. The first sealing rings 40 are made of elastic material, such as rubber or silicone, so that each of the first sealing rings 40 effectively fill the gap between the corresponding cup seat 34 and the corresponding connecting piece 21 (such as the locking screw 212), thereby preventing gas leakage and maintain the negative pressure environment inside each of the suction cups 30, ensuring that the suction cups 30 firmly suck the at least one ski board 6, and improving the suction effect and stability of the suction cups 30.

In some embodiments, each cup body 32 is made from a flexible material, such as a rubber material, which has good elasticity and deformation ability. Therefore, each cup body 32 fits closely to the surface of the at least one ski board 6, and maintain good sealing even on an uneven surface, thereby improving the suction effect. Each cup seat 34 may be made of metal, such as an aluminum alloy material, which has high strength and rigidity. Therefore, each cup seat 34 is able to withstand locking force of the corresponding connecting piece 21 (such as the locking screw 212) and the suction force of the corresponding one of the suction cups 30, thereby ensuring that each of the suction cups 30 is not deformed or damaged during the maintenance process.

In some embodiments, each connecting piece 21 (such as each locking screw 212) comprises an axial through hole. Each cup seat 34 comprises an opening 341 communicated with an interior of a corresponding one of the suction cups 30. Each opening 341 is further communicated with a corresponding axial through hole.

Each of the mounting assemblies 20 further comprises a pressure relief rod 23 23, a sealing piece 24, and a driving portion 25. Each pressure relief rod 23 is disposed in a corresponding axial through hole. Each sealing piece 24 is disposed between a first end of a corresponding pressure relief rod 23 and the corresponding cup seat 34. A second end of each pressure relief rod 23 is connected to a corresponding driving portion 25. Each driving portion 25 is configured to drive a corresponding pressure relief rod 23 to move toward or away from a corresponding cup seat 34 to seal or expose the opening 341 of a corresponding cup seat 34.

In the embodiment, each pressure relief rod 23 cooperates with the corresponding sealing piece 24 and the corresponding driving portion 25. The user is allowed to quickly achieve the pressure relief or sealing operation of each of the suction cups 30 through each pressure relief rod 23. When it is necessary to fix the at least one ski board 6, each driving portion 25 drives the corresponding pressure relief rod 23 close to the corresponding cup seat 34, so that the corresponding sealing piece 24 seals the opening 341 of the corresponding cup seat 34. In this way, the negative pressure is formed inside each of the suction cups 30 to suck the at least one ski board 6. When it is necessary to remove at least one ski board 6, each driving portion 25 drives the corresponding pressure relief rod 23 to move away from the corresponding cup seat 34, so that the opening 341 of the corresponding cup seat 34 is exposed. At this time, the inside of each of the suction cups 30 is communicated with the outside, and the suction force is quickly released.

Exemplarily, each driving portion 25 is a pressure relief lever 252. Each pressure relief lever 252 is rotatably connected to the corresponding pressure relief rod 23. The user only needs to pull any pressure relief lever 252 to complete the pressure relief or sealing of the corresponding one of the suction cups 30, without manually operating complex components, thereby improving the convenience of operation. Each sealing piece 24 is a sealing ring or a sealing sheet. Each sealing piece 24 may adopt a structure such as the sealing ring or the sealing sheet, which good elasticity and sealing performance. Therefore, it is ensured that when each pressure relief rod 23 is away from the corresponding cup seat 34, the opening 341 of the corresponding cup seat 34 is tightly sealed.

In some embodiments, each of the mounting assemblies 20 further comprises an elastic piece 26. Each elastic piece 26 is elastically connected to a corresponding pressure relief rod 23. Each elastic piece 26 is configured to provide elastic force to force a corresponding pressure relief rod 23 and a corresponding sealing piece 24 to seal the opening 341 of a corresponding cup seat 34.

In the embodiment, the function of each elastic piece 26 is to provide continuous elastic force for the corresponding pressure relief rod 23, so that the corresponding pressure relief rod 23 maintains a close fit with the corresponding sealing piece 24 when not subject to external force, thereby sealing the opening 341 of the corresponding cup seat 34. Specifically, each elastic piece 26 is a spring. When each elastic piece 26 is in an elastic deformation state, such as a compressed state, each elastic piece 26 provides elastic force to move the corresponding pressure relief rod 23 toward the corresponding cup seat 34, so that the corresponding sealing piece 24 presses the corresponding opening 341 of the cup seat 34. At this time, the negative pressure environment is formed inside the corresponding one of the suction cups 30, ensuring that each of the suction cups 30 maintains a stable suction force when fixing the at least one ski board 6. Even in the case of slight vibration, the suction cups 30 are able to maintain good sealing performance, thereby effectively avoiding the problem of insufficient suction or air leakage caused by poor sealing and improving the stability and reliability of the suction cups 30. When the user overcomes the elastic force of the elastic piece 26 through each driving portion 25, each pressure relief rod 23 moves away from the corresponding cup seat 34, so that the corresponding sealing piece 24 leaves the opening 341 of the corresponding cup seat 34, and the gas is discharged through the opening 341 of the corresponding cup seat 34 and the corresponding axial through hole, thereby achieving rapid pressure relief. When the user releases each driving portion 25, the elastic force of each elastic piece 26 drives the corresponding pressure relief rod 23 to reset, and the corresponding sealing piece 24 reseals the opening 341 of the corresponding cup seat 34. Such automatic sealing function does not require the user to manually adjust the sealing state, thereby improving the convenience and reliability of the maintenance support 1.

In some embodiments, each pressure relief rod 23 has a first section 232 and a second section 234 connected to the first section 232. A first end of the first section 232 of each pressure relief rod 23 away from a corresponding second section 234 is connected to a corresponding sealing piece 24. A diameter of each second section 234 is less than a diameter of each first section 232. Each elastic piece 26 is sleeved on a corresponding second section 234. Each of the mounting assemblies 20 further comprises a limiting portion 27. Each limiting portion 27 is mounted on a corresponding second section 234 and located on one side of a corresponding elastic piece 26 away from a corresponding first section 232. Each elastic piece 26 is elastically mounted between a corresponding second section 234 and a corresponding limiting portion 27.

In the embodiment, each pressure relief rod 23 is divided into the first section 232 and the second section 234 that are of different diameters. The second section 234 thereof with a smaller diameter provides a stable support and installation position for each elastic piece 26, so that each elastic piece 26 is smoothly mounted thereon. The segmented design of each pressure relief rod 23 makes the mounting of each elastic piece 26 more convenient and reduces the difficulty of assembly. By mounting each elastic piece 26 between the corresponding second section 234 and the corresponding limiting portion 27, the corresponding second section 234 and the corresponding limiting portion 27 limit each elastic piece 26, which prevents each elastic piece 26 from being displaced or falling off during operation. Each elastic piece 26 may be a spring.

In some embodiments, each limiting portion 27 comprises a gasket 272 and a stop ring 274. Each gasket 272 and each stop ring 274 are sleeved on a corresponding second section 234. Each gasket 272 is disposed between a corresponding elastic piece 26 and a corresponding stop ring 274. Each stop ring 274 is mounted in a corresponding second section 234.

In the embodiment, each stop ring 274 is mounted on the second section 234 of the corresponding pressure relief rod 23. For example, each stop ring 274 is clamped on the second section 234 of the corresponding pressure relief rod 23, which ensures the firmness of each limiting portion 27 and limits each elastic piece 26 to prevent each elastic piece 26 from falling off or shifting during movement. Each gasket 272 is disposed between the corresponding elastic piece 26 and the corresponding stop ring 274 to prevent the corresponding elastic piece 26 from directly contacting the corresponding stop ring 274. In this way, wear of each elastic piece 26 is reduced and service life of each elastic piece 26 is extended. The design of each gasket 272 and each stop ring 274 makes the mounting and removal of each elastic piece 26 more convenient, which is convenient for users to maintain or replace each elastic piece 26.

In other embodiments, each stop ring 274 may be sleeved on the second section 234 of the corresponding pressure relief rod 23 and adjacent to the second corresponding one of the second plates 14, so that the corresponding elastic piece 26 is limited by the corresponding first section 232 and the corresponding one of the second plates 14. In some embodiments, each of the mounting assemblies 20 does not comprise the limiting portion 27, but each elastic piece 26 may be limited directly by the corresponding one of the second plates 14 and the corresponding first section 232.

In some embodiments, one end of a side wall of each axial through hole close to a corresponding cup seat 34 defines an inclined surface. A protrusion 233 protruding toward a corresponding cup seat 34 is disposed on each first section 232. Each sealing piece 24 comprises a second sealing ring. Each second sealing ring is sleeved on a corresponding protrusion 233. Each elastic piece 26 enables each second sealing ring to abut between the corresponding protrusion 233 and the inclined surface of a corresponding axial through hole to seal a corresponding opening 341. Each driving portion 25 is configured to drive the corresponding pressure relief rod 23 to drive a corresponding second sealing ring to move, so that each second sealing ring separates from the inclined surface of the corresponding protrusion 233 and exposes the corresponding opening 341.

In the embodiment, rapid pressure relief and reliable sealing of each of the suction cups 30 are realized by designing the inclined surface of each axial through hole, each protrusion 233, and each second sealing ring. Specifically, when each elastic piece 26 is in the elastic deformation state, such as the compressed state, each elastic piece 26 provides elastic force to make the corresponding second sealing ring abut between the corresponding protrusion 233 and the corresponding inclined surface of the axial through hole to seal the corresponding opening 341 and prevent gas leakage, thereby maintaining the negative pressure environment inside each of the suction cups 30 and ensuring that each of the suction cups 30 firmly sucks the at least one ski board 6. When the user overcomes the elastic force of each elastic piece 26 through the corresponding driving portion 25, each pressure relief rod 23 drives the corresponding second sealing ring to move, and the corresponding second sealing ring leaves the inclined surface of the corresponding axial through hole to expose the opening 341 of each cup seat 34. At this time, the gas is discharged through each opening 341 and each axial through hole, realizing rapid pressure relief of each of the suction cups 30, and facilitating the removal of the at least one ski board 6. When the user releases any driving portion 25, the elastic force of the corresponding elastic piece 26 drives the corresponding pressure relief rod 23 to reset, and the corresponding second sealing ring abuts against the inclined surface of the corresponding axial through hole again to restore the sealing state, and the opening 341 of the corresponding cup seat 34 is sealed again to restore the suction function of the corresponding one of the suction cups 30.

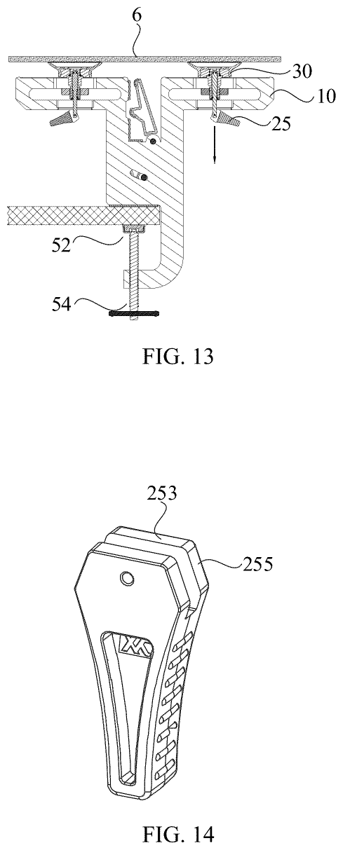

As shown in FIGS. 12-13, FIG. 12 is a schematic diagram of the maintenance support shown in FIG. 6 where the suction cups are pressed downward, and FIG. 13 is a schematic diagram of the maintenance support shown in FIG. 12 where each driving portion is in the second position. In some embodiments, each driving portion 25 is rotatably connected to the corresponding pressure relief rod 23, and each driving portion 25 is rotatable between a first position and a second position. When each driving portion 25 is in the first position, each driving portion 25 and a corresponding one of the second plates 14 are spaced apart from each other, and each elastic piece 26 enables the corresponding second sealing ring to abut between the corresponding protrusion 233 and the inclined surface of the corresponding axial through hole to seal the corresponding opening 341. When each driving portion 25 is in the second position, each driving portion 25 drives the corresponding pressure relief rod 23 to drive the corresponding second sealing ring to move, so that each second sealing ring separates from the inclined surface of the corresponding axial through hole and exposes the corresponding opening 341.

In the embodiment, each driving portion 25 is rotatably connected to the corresponding pressure relief rod 23 so that the user is able to seal or expose each opening 341 through a simple rotation operation without additional tools. The operation is convenient and efficient, which significantly improves the practicality and user experience of the maintenance support 1.

In some embodiments, each driving portion 25 comprises a pressure relief lever 252 and a lever pin 256. A first mounting hole is defined on a second end of each pressure relief rod 23. A second mounting hole is defined on each pressure relief lever 252. Each lever pin 256 is disposed in a corresponding first mounting hole and a corresponding second mounting hole, so that each pressure relief lever 252 is rotatably connected to a corresponding pressure relief rod 23. Each pressure relief lever 252 is rotatable relative to the corresponding pressure relief rod 23 between the first position and the second position, so that each second sealing ring seals or exposes the corresponding opening 341.

In the embodiment, each pressure relief lever 252 is an operating component of the corresponding driving portion 25, and the user realizes the sealing or pressure relief of each of the suction cups 30 by turning each pressure relief lever 252. Each pressure relief lever 252 is rotatably connected to the corresponding pressure relief rod 23 through the corresponding lever pin 256, and each pressure relief lever 252 is rotatable between the first position and the second position relative to the corresponding pressure relief rod 23, so that the corresponding second sealing ring seals or exposes the corresponding opening 341. Specifically, when each pressure relief lever 252 is in the first position, there is a gap between each pressure relief lever 252 and the corresponding one of the second plates 14, and the corresponding elastic piece 26 provides elastic force, so that the corresponding second sealing ring is tightly fitted to the inclined surface of the corresponding axial through hole, thereby sealing the corresponding opening 341 and realizing the sealing function of the corresponding one of the suction cups 30. When each pressure relief lever 252 rotates to the second position, each pressure relief lever 252 drives the corresponding pressure relief rod 23 to move through the corresponding lever pin 256, so that the corresponding second sealing ring leaves the inclined surface of the corresponding axial through hole and exposes the corresponding opening 341. At this time, the gas is discharged through each opening 341 and each axial through hole to achieve pressure relief of each of the suction cups 30. Therefore, by rotatably connecting each pressure relief lever 252 and the corresponding lever pin 256, each driving portion 25 realizes a simple and efficient driving mechanism. The user only needs to turn any pressure relief lever 252 to easily achieve the movement of the corresponding pressure relief rod 23, thereby controlling the sealing or pressure relief state of the corresponding second sealing ring, reducing operating steps when fixing or removing the at least one ski board 6. No additional tools are required during the maintenance process, thereby improving the use efficiency of the maintenance support 1.

For example, for the snowboard that is relatively wide, the suction cups 30 evenly distribute the suction force, which effectively prevent the snowboard 6 from being unevenly stressed due to its large width, and avoid tilting or shaking during the maintenance process. For the two ski blades that are relatively narrow, the suction cups 30 respectively suck the two ski blades 6 at the same time, so that each of the ski blades 6 is fixed separately. By adjusting the position of each of the suction cups 30, mutual interference between the two ski blades 6 is avoided.

As shown in FIG. 14, FIG. 14 is a schematic diagram of the pressure relief lever of the maintenance support shown in FIG. 1. In some embodiments, each pressure relief lever 252 comprises a first surface 253 and a second surface 255 adjacent to the first surface 253. A minimum distance between the first surface 253 of each pressure relief lever 252 and a corresponding second mounting hole is less than a minimum distance between the second surface 255 of each pressure relief lever 252 and a corresponding second mounting hole. When each pressure relief lever 252 is in the first position, the first surface 253 of each pressure relief lever 252 is opposite to and spaced from a corresponding one of the second plates 14. When each pressure relief lever 252 is in the second position, the second surface 255 of each pressure relief lever 252 abuts against a corresponding one of the second plates 14 and drives a corresponding pressure relief rod 23, and each pressure relief rod 23 drives the corresponding second seal ring to move.

In the embodiment, the minimum distance between the first surface 253 of each pressure relief lever 252 and the corresponding second mounting hole is small, so that when each pressure relief lever 252 is in the first position, a certain distance is defined between each pressure relief lever 252 and the corresponding one of the second plates 14, and no additional driving force is generated on the corresponding pressure relief rod 23. At this time, each elastic piece 26 is in the elastic deformation state, such as the compressed state, providing elastic force to make the corresponding pressure relief rod 23 move toward the corresponding one of the suction cups 30, pushing the corresponding second sealing ring to abut between the corresponding protrusion 233 and the inclined surface of the corresponding axial through hole, thereby sealing the corresponding opening 341. The minimum distance between the second surface 255 of each pressure relief lever 252 and the corresponding second mounting hole is relatively large, so that when each pressure relief lever 252 is in the second position, each pressure relief lever 252 is in close contact with the corresponding one of the second plates 14, thereby driving the corresponding pressure relief rod 23 to move through the lever principle. At this time, each pressure relief rod 23 further compresses the corresponding elastic piece 26, and at the same time drives the corresponding second sealing ring to leave the inclined surface of the corresponding axial through hole, exposing the corresponding opening 341, thereby achieving the pressure relief of the corresponding one of the suction cups 30. In the embodiment, when each pressure relief lever 252 is rotated to different positions, each pressure relief lever 252 drives the corresponding pressure relief rod 23 to move toward or away from the corresponding one of the suction cups 30 through adjusting a relative position of the first surface 253 or the second surface 255 of each pressure relief lever 252 and the corresponding one of the second plates 14, thereby achieving the sealing or pressure relief of the corresponding one of the suction cups 30.

In some embodiments, the maintenance support 1 further comprises a mounting piece 50, and the mounting piece 50 is detachably mounted on a bearing portion.

In the embodiment, the mounting piece 50 is configured to detachably mount the maintenance support 1 on the bearing portion. For example, the bearing portion is a table or other stable support structure, so that the maintenance support 1 can be mounted on different bearing portions as needed. The mounting piece 50 may adopt a variety of detachable connection methods, such as buckles, bolts, clamps, etc., to ensure that the maintenance support 1 is firmly mounted on the bearing portion. For example, the user may fix the maintenance support 1 on the table, a workbench, or other suitable support structure according to actual needs, thereby providing a stable operating platform for the maintenance of the at least one ski board 6.

In some embodiments, the support body 10 comprises a first mounting plate 16 and a second mounting plate 18 disposed opposite to the first mounting plate 16. The mounting piece 50 comprises a mounting seat 52 and a mounting screw 54. The mounting seat 52 is disposed between the first mounting plate 16 and the second mounting plate 18. The mounting screw 54 passes through the second mounting plate 18 and is screwed with the second mounting plate 18. The mounting seat 52 is fixedly connected to the mounting screw 54.

In the embodiment, the mounting seat 52 is disposed between the first mounting plate 16 and the second mounting plate 18, and the mounting screw 54 is screwed with the second mounting plate 18, which ensures a tight connection between the mounting piece 50 and the support body 10, prevents the mounting piece 50 from loosening or falling off during use, and improves the overall stability of the maintenance support 1. When mounting the mounting piece 50 on the support body 10, the user only needs to place the mounting seat 52 between the first mounting plate 16 and the second mounting plate 18, and then screw the mounting screw 54 to the second mounting plate 18 to complete the installation, thereby simplifying the mounting process.

In some embodiments, an axial direction of the mounting screw 54 intersects with the first direction. The second mounting plate 18 is adjacent to one side of the first mounting plate 16 away from the suction cups 30.

In the embodiment, the axial direction of the mounting screw 54 intersects with the first direction, so that the mounting screw 54 is mounted perpendicular to the bearing portion. The user only needs to rotate the mounting screw 54 in a forward direction to easily fix the maintenance support 1 on the bearing portion. The user may also rotate the mounting screw 54 in a reverse direction to easily detach the maintenance support 1 from the bearing portion. The second mounting plate 18 is disposed on one side of the first mounting plate 16 away from the suction cups 30. That is, the second mounting plate 18 is located at a bottom portion of the support body 10, close to the bearing portion. Such configuration separates the position of the mounting piece 50 from the suction cups 30 to avoid interference. The mounting piece 50 is disposed at the bottom portion of the support body 10, and the user is able to complete the mounting or detachment of the maintenance support 1 through a simple rotation operation without any additional tools. Such configuration not only improves the mounting convenience, but also enhances the stability and reliability of the maintenance support 1, thereby allowing the user to more easily perform maintenance operations on the at least one ski board 6 during use.

In some embodiments, the support body 10 is made of metal. The support body 10 made of metal has high strength and durability. Therefore, the support body 10 easily bears a weight of the at least one ski board 6 and various impact forces that generated during the maintenance process, thereby ensuring that the support body 10 is not easily deformed or damaged during long-term use, and extending the service life of the support body 10. Further, the support body 10 made of metal has rigidity and stability, which provides stable support for the at least one ski board 6, ensures the stability of the maintenance support 1 during the fixing and maintenance process, reduces maintenance errors caused by shaking or instability, and improves the safety and reliability of maintenance operations. In addition, the support body 10 made of metal generally has good corrosion resistance and effectively resists erosion by humid environments and chemicals, which is particularly important for the support body that may contact snow water and detergents during the maintenance of the at least one ski board 6, thereby ensuring that the support body 10 maintains good performance.

In some embodiments, a diameter of each of the suction cups 30 is less than 80 mm.

If the diameter of the each of the suction cups 30 is large, for the at least one ski board 6 with a small width, such as the two ski blades 6, the suction cups 30 with a large diameter cannot effectively suck the two ski blades 6. Therefore, the diameter of each of the suction cups 30 is configured to be less than 80 mm, such as 70 mm, 60 mm, 50 mm, etc. The small diameter of each of the suction cups 30 allows the suction cups 30 to apply suction force more concentratedly, ensuring that the at least one ski board 6 is stably fixed during the maintenance process. Therefore, the suction cups 30 better adapt to the surface of the at least one ski board 6 with a small width, avoiding the situation where the suction cups 30 are too large and are unable to firmly suck the at least one ski board or unable to be used. Thus, the suction cups 30 can adapt to the ski boards 6 of different widths, especially the two ski blades 6 with a small width, thereby improving the versatility of the maintenance support 1 and being able to adapt to a variety of ski board types.

In some embodiments, the maintenance support 1 is further define a locking groove configured to limit a position of the at least one ski board 6. For example, the at least one ski board 6 is inserted into the locking groove, a locking portion disposed in the locking groove, and the locking portion clamps the at least one ski board 6 along a thickness direction of the at least one ski board 6. The locking groove may be defined between the two first plates defining the first sliding grooves, and the first mounting plate and the second mounting plate are disposed below the locking groove.

In some embodiments, the maintenance support 1 is configured to suck external objects such as the at least one ski board 6. For example, the suction cups 30 of the maintenance support 1 are sucked in a middle portion of the at least one ski board 6. Alternatively, the suction cups 30 of the maintenance support 1 are sucked in the middle portion of the sat least one ski board 6, and other positions of the at last one ski board 6, such as two ends thereof, are supported by other supporting structures such as block-shaped support platforms.

In some embodiments, a plurality of maintenance supports 1 are cooperated with each other to suck external objects such as the at least one ski board 6. For example, two maintenance supports 1 are disposed at intervals, and the suction cups 30 of the two maintenance supports 1 are respectively sucked on different positions of the at least one ski board 6 to stably suck the at least one ski board 6. Specifically, the suction cups 30 of the two maintenance supports 1 suck both ends of the at least one ski board 6, or suck other positions of the at least one ski board 6. For another example, three or more maintenance supports 1 are disposed at intervals, and the suction cups 30 of the three or more maintenance supports 1 are respectively sucked on different positions of the at least one ski board 6 to stably suck the at least one ski board 6. The three or more maintenance supports 1 may be disposed in sequence along a length direction of the at least one ski board 6.

The present disclosure further provides a maintenance support assembly. The maintenance support assembly comprises the at least one ski board 6 and the maintenance support 1 mentioned above. The suction cups 30 are attached to the at least one ski board 6.

The maintenance support 1 sucks the at least one ski board 6 through the suction cups 30, realizes the rapid fixation and removal of the at least one ski board 6, and provides a better user experience for the maintenance of the at least one ski board 6. The support body 10 of the maintenance support 1 may be made of aluminum alloy die-casting, which has high strength and rigidity and effectively prevents the support body 10 from deforming and shaking due to force when the at least one ski board 6 is maintained. The first sliding grooves 121 are defined on the support body 10, and the suction cups 30 are mounted on different mounting assemblies 20. The positions of the suction cups 30 are adjusted with the movement of the mounting assemblies 20. The suction cups 30 are configured to suck and fix the at least one ski board 6, and the cup body 32 of each of the suction cups 30 may be made of flexible material, such as high tear-resistant silicone material, to ensure the suction and fixation of each of the suction cups 30. The user is allowed to flexibly adjust the position between the suction cups 30 by separately adjusting the position of each of the suction cups 30 in the corresponding one of the first sliding grooves 121, so the suction cups move closer or away from each other, thereby adapting to ski boards 6 of different sizes. The maintenance support 1 can not only adapt to ski boards 6 of different sizes, but also can adapt to different types of ski board 6, including the snowboard and the pair of ski blades, which significantly improves practicality and adaptability of the maintenance support 1. In addition, one or more maintenance supports 1 are provided to suck and support the at least one ski board 6.

In the above-mentioned embodiments, descriptions of each embodiment have their own emphasis. For parts that are not described in detail or recorded in one embodiment, reference may be made to related descriptions of other embodiments. The embodiments, implementations and related technical features of the present disclosure can be combined and replaced with each other without conflict.

The above embodiments of the present disclosure provide a detailed illustration to the maintenance support and the maintenance support assembly. In the present disclosure, specific embodiments are applied to illustrate the principles and implementations of the present disclosure. The above description of the embodiments is only used to better understand methods and core ideas of the present disclosure. Meanwhile, according to the ideas of the present disclosure, changes are made in the specific implementations and the application scope by those skilled in the art. Therefore, the contents of the specification should not be regarded as a limitation of the present disclosure.

What is claimed is:

1. A maintenance support, comprising:
a support body;
suction cups;
mounting assemblies;
wherein the support body comprises first sliding grooves, the first sliding grooves extend in a first direction, each of the mounting assemblies is movably mounted in a corresponding one of the first sliding grooves and is movable in the corresponding one of the first sliding grooves along the first direction, each of the suction cups is mounted on a corresponding one of the mounting assemblies, and the suction cups are close to or away from each other through the mounting assemblies.

2. The maintenance support according to claim 1, wherein the first sliding grooves are disposed at intervals in the first direction, the mounting assemblies are one-to-one mounted in the first sliding grooves, and the suction cups are one-to-one corresponding to the first sliding grooves.

3. The maintenance support according to claim 2, wherein each of the mounting assemblies comprises a connecting piece and a locking piece, a first end of each connecting piece is connected to a corresponding one of the suction cups, each connecting piece passes through a corresponding one of the first sliding grooves in a second direction, a second end of each connecting piece is connected to a corresponding locking piece, each locking piece cooperates with the second end of a corresponding connecting piece to lock or unlock a corresponding one of the suction cups relative to the support body, and the second direction intersects with the first direction.

4. The maintenance support according to claim 3, wherein each connecting piece comprises a locking screw, each locking screw is screwed with a corresponding one of the suction cups, each locking screw passes through a corresponding one of the first sliding grooves, each locking piece comprises a nut, and each nut is screwed with a corresponding locking screw.

5. The maintenance support according to claim 3, wherein the support body comprises first plates and second plates disposed opposite to first plates, the first sliding grooves are respectively defined on the first plates, second sliding grooves corresponding to the first sliding grooves are respectively defined on the second plates, the first plates and the second plates are disposed at intervals, a spacing groove is defined between each of the first plates and a corresponding one of the second plates, each connecting piece further passes through a corresponding spacing groove and a corresponding one of the second sliding grooves, and each locking piece is disposed in a corresponding spacing groove.

6. The maintenance support according to claim 5, wherein each of the suction cups abuts against a corresponding one of the first plates, each of the suction cups comprises a cup body and a cup seat, each cup body is disposed around a corresponding cup seat, and each cup seat is screwed with a corresponding connecting piece;
wherein the maintenance support further comprises first sealing rings, and each of the first sealing rings is disposed between a corresponding cup seat and a corresponding connecting piece.

7. The maintenance support according to claim 6, wherein each connecting piece comprises an axial through hole, each cup seat comprises an opening communicated with an interior of a corresponding one of the suction cups, and each opening is further communicated with a corresponding axial through hole;
wherein each of the mounting assemblies further comprises a pressure relief rod, a sealing piece, and a driving portion, each pressure relief rod is disposed in a corresponding axial through hole, each sealing piece is disposed between a first end of a corresponding pressure relief rod and a corresponding cup seat, a second end of each pressure relief rod is connected to a corresponding driving portion, each driving portion is configured to drive a corresponding pressure relief rod to move toward or away from a corresponding cup seat to seal or expose the opening of a corresponding cup seat.

8. The maintenance support according to claim 7, wherein each of the mounting assemblies further comprises an elastic piece, each elastic piece is elastically connected to a corresponding pressure relief rod, and each elastic piece is configured to provide elastic force to force a corresponding pressure relief rod and a corresponding sealing piece to seal the opening of a corresponding cup seat.

9. The maintenance support according to claim 8, wherein each pressure relief rod has a first section and a second section connected to the first section, a first end of the first section of each pressure relief rod away from a corresponding second section is connected to a corresponding sealing piece, a diameter of each second section is less than a diameter of each first section, and each elastic piece is sleeved on a corresponding second section;
wherein each of the mounting assemblies further comprises a limiting portion, each limiting portion is mounted on a corresponding second section and located on one side of a corresponding elastic piece away from a corresponding first section, and each elastic piece is elastically mounted between a corresponding second section and a corresponding limiting portion.

10. The maintenance support according to claim 9, wherein each limiting portion comprises a gasket and a stop ring, each gasket and each stop ring are sleeved on a corresponding second section, each gasket is disposed between a corresponding elastic piece and a corresponding stop ring, and each stop ring is mounted in a corresponding second section.

11. The maintenance support according to claim 9, wherein one end of a side wall of each axial through hole close to a corresponding cup seat defines an inclined surface; a protrusion protruding toward a corresponding cup seat is disposed on each first section, each sealing piece comprises a second sealing ring, and each second sealing ring is sleeved on a corresponding protrusion;
wherein each elastic piece enables each second sealing ring to abut between the corresponding protrusion and the inclined surface of a corresponding axial through hole to seal a corresponding opening; each driving portion is configured to drive the corresponding pressure relief rod to drive a corresponding second sealing ring to move, so that each second sealing ring separates from the inclined surface of the corresponding protrusion and exposes the corresponding opening.

12. The maintenance support according to claim 11, wherein each driving portion is rotatably connected to the corresponding pressure relief rod, and each driving portion is rotatable between a first position and a second position;
wherein when each driving portion is in the first position, each driving portion and a corresponding one of the second plates are spaced apart from each other, and each elastic piece enables the corresponding second sealing ring to abut between the corresponding protrusion and the inclined surface of the corresponding axial through hole to seal the corresponding opening;
wherein when each driving portion is in the second position, each driving portion drives the corresponding pressure relief rod to drive the corresponding second sealing ring to move, so that each second sealing ring separates from the inclined surface of the corresponding axial through hole and exposes the corresponding opening.

13. The maintenance support according to claim 12, wherein each driving portion comprises a pressure relief lever and a lever pin, a first mounting hole is defined on a second end of each pressure relief rod, a second mounting hole is defined on each pressure relief lever, and each lever pin is disposed in a corresponding first mounting hole and a corresponding second mounting hole, so that each pressure relief lever is rotatably connected to a corresponding pressure relief rod;
wherein each pressure relief lever is rotatable relative to the corresponding pressure relief rod between the first position and the second position, so that each second sealing ring seals or exposes the corresponding opening.

14. The maintenance support according to claim 13, wherein each pressure relief lever comprises a first surface and a second surface adjacent to the first surface, and a minimum distance between the first surface of each pressure relief lever and a corresponding second mounting hole is less than a minimum distance between the second surface of each pressure relief lever and a corresponding second mounting hole;
wherein when each pressure relief lever is in the first position, the first surface of each pressure relief lever is opposite to and spaced from a corresponding one of the second plates, and when each pressure relief lever is in the second position, the second surface of each pressure relief lever abuts against a corresponding one of the second plates and drives a corresponding pressure relief rod, and each pressure relief rod drives the corresponding second seal ring to move.

15. The maintenance support according to claim 1, wherein the maintenance support further comprises a mounting piece, and the mounting piece is detachably mounted on a bearing portion.

16. The maintenance support according to claim 15, wherein the support body comprises a first mounting plate and a second mounting plate disposed opposite to the first mounting plate;
wherein the mounting piece comprises a mounting seat and a mounting screw, the mounting seat is disposed between the first mounting plate and the second mounting plate, the mounting screw passes through the second mounting plate and is screwed with the second mounting plate, and the mounting seat is fixedly connected to the mounting screw.

17. The maintenance support according to claim 16, wherein an axial direction of the mounting screw intersects with the first direction, and the second mounting plate is adjacent to one side of the first mounting plate away from the suction cups.

18. The maintenance support according to claim 1, wherein the support body is made of metal.

19. The maintenance support according to claim 1, wherein a diameter of each of the suction cups is less than 80 mm.

20. A maintenance support assembly, comprising:
at least one ski board; and
the maintenance support according to claim 1;
wherein the suction cups are attached to the at least one ski board.
